(19) United States
(12) Patent Application Publication
(10) Pub. No.: US 2021/0272182 A1
(43) Pub. Date: Sep. 2, 2021

(54) Product Information Presentation And Smart Purchase System And Method Thereof

(71) Applicants: Inventec (Pudong) Technology Corporation, Shanghai (CN); Inventec Corporation, Taipei City (TW)

(72) Inventor: Chaucer Chiu, Taipei City (TW)

(21) Appl. No.: 16/899,393

(22) Filed: Jun. 11, 2020

(30) Foreign Application Priority Data
Mar. 2, 2020 (CN) 202010135549.7

(51) Int. Cl. G06Q 30/06; G06Q 10/08; G06Q 30/02; G06K 7/14; G06K 7/10; G06F 16/53; G06T 19/00

(52) U.S. Cl. CPC G06Q 30/0633; G06Q 30/0623; G06Q 30/0643; G06Q 10/083; G06T 19/006; G06K 7/1417; G06K 7/10722; G06F 16/53; G06Q 30/0241

(57) ABSTRACT

A product information presentation and smart purchase system and a method thereof are provided. In the system, a handheld device provides a product barcode image having one of a plurality of two-dimensional product barcodes to a server, and the server transmits a three-dimensional product image and product display information back to the handheld device. The handheld device displays the three-dimensional product image in augmented reality and provides a virtual shopping user interface. A user can purchase a product corresponding to the one of the plurality of two-dimensional product barcodes through the virtual shopping user interface and the three-dimensional product image, and then the handheld device generates and provides a purchase order to a merchant server. The merchant server performs delivery of the purchased product based on the purchase order. As a result, the technical effect of displaying the product in augmented reality for smart purchase can be achieved.

### CROSS-REFERENCE TO RELATED APPLICATION

This application claims the benefit of Chinese Application Serial No. 202010135549.7, filed Mar. 2, 2020, which is hereby incorporated herein by reference in its entirety.

### BACKGROUND OF THE INVENTION

### 1. Field of the Invention

The present invention relates to a product information presentation and smart purchase system and a method thereof, and more particularly to a system capable of presenting product information in augmented reality for smart purchase, and a method thereof.

### 2. Description of the Related Art

Existing advertisements for products only provide and display partial information of the products, and do not provide complete product information to consumers. For example, consumers only know that the products in the advertisement are on sale, but they may not know that the products in the advertisement are almost expired products; furthermore, consumers also must take time to go to the store to purchase the products, and it causes inconvenience to both consumers and merchants.

In summary, it can be seen that there are conventional technical problems in the prior art that the existing product advertisement is not effective and it is inconvenient to purchase the product which is in the advertisement, and what is needed is to propose an improved technical solution to solve these problems.

### SUMMARY OF THE INVENTION

In order to solve the conventional technical problems that the existing product advertisement is not effective and it is inconvenient to purchase the product that is in the advertisement, the present invention provides a product information presentation and smart purchase system and a method thereof.

According to an embodiment, the product information presentation and smart purchase system includes a handheld device, a server, and a merchant server. The handheld device includes a device receiving module, an image module, a purchase module, and a device transmitting module. The server includes a server receiving module, a decoding module, a query module, and a server transmitting module.

A plurality of two-dimensional product barcodes are provided. In an embodiment, the two-dimensional product barcode can be presented on a physical device, a physical location, or a virtual display.

The device receiving module of the handheld device is configured to receive a three-dimensional product image and at least one piece of product display information. The image module of the handheld device is configured to obtain a product barcode image having one of the plurality of two-dimensional product barcodes on an augmented reality image, and display the three-dimensional product image at a position of the one of the plurality of two-dimensional product barcodes on the augmented reality image, and provide a virtual shopping user interface, and display the at least one piece of product display information on the three-dimensional product image when the three-dimensional product image is presented with a specific view angle. The purchase module is configured to purchase a product corresponding to the one of the plurality of two-dimensional product barcodes through the virtual shopping user interface and the three-dimensional product image, and generate a purchase order. The device transmitting module of the handheld device is configured to transmit the product barcode image, and transmit the purchase order.

The server receiving module of the server is configured to receive the product barcode image from the device transmitting module. The decoding module of the server is configured to decode the one of the plurality of two-dimensional product barcodes on the product barcode image, to obtain product information. The query module of the server is configured to query the three-dimensional product image and the at least one piece of product display information corresponding to the product information. The server transmitting module of the server is configured to transmit the three-dimensional product image and the at least one piece of product display information to the device receiving module. The merchant server of the server is configured to receive the purchase order from the device transmitting module, and perform delivery of the purchased product.

According to an embodiment, the product information presentation and smart purchase method includes following steps of: providing a plurality of two-dimensional product barcodes; obtaining, by a handheld device, a product barcode image having one of the plurality of two-dimensional product barcodes on an augmented reality image; transmitting, by the handheld device, the product barcode image to a server; decoding, by the server, the one of the plurality of two-dimensional product barcodes on the product barcode image to obtain product information; querying, by the server, a three-dimensional product image and at least one piece of product display information corresponding to the product information; transmitting, by the server, the three-dimensional product image and the at least one piece of the product display information to the handheld device; displaying, by the handheld device, the three-dimensional product image at a position of the one of the plurality of two-dimensional product barcodes on the augmented reality image, and providing a virtual shopping user interface; when the three-dimensional product image displayed on the augmented reality image being presented with a specific view angle, displaying, by the handheld device, the at least one piece of product display information on the three-dimensional product image; purchasing a product corresponding to the one of the plurality of two-dimensional product barcodes through the virtual shopping user interface and the three-dimensional product image, and then generating, by the handheld device, a purchase order; transmitting, by the handheld device, the purchase order to a merchant server; and performing, by the merchant server, delivery of the purchased product based on the purchase order.

According to the above-mentioned contents, the difference between the system and method of the present invention and the conventional technology is that the handheld device can provide the product barcode image having one of the two-dimensional product barcodes to the server, the server then transmits the three-dimensional product image and the at least one piece of product display information back to the handheld device, the handheld device then displays the three-dimensional product image in augmented reality to provide the virtual shopping user interface, the product corresponding to the one of the plurality of two-dimensional product barcodes can be purchased through the virtual shopping user interface and the three-dimensional product image, and the handheld device generates and provides the purchase order to the merchant server, and the merchant server performs delivery of the purchased product based on the purchase order.

Therefore, the technical solution of the present invention can achieve the technical effect of displaying the product in augmented reality for smart purchase.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a product information presentation and smart purchase system of the present invention.

FIG. 2 is a schematic view of a plurality of two-dimensional product barcodes in the product information presentation and smart purchase system of the present invention.

FIG. 3A is a schematic view of an augmented reality image in the product information presentation and smart purchase system of the present invention.

FIG. 3B is a schematic view of product display information in the product information presentation and smart purchase system of the present invention.

FIGS. 4A and 4B are flowcharts of a product information presentation and smart purchase method of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

The embodiments of the present invention will be illustrated in detail in following paragraphs with reference to the accompanying drawings, so that those skilled in the art would realize the technical solution and implementation of the present invention to solve the technical problem and achieve technical effect.

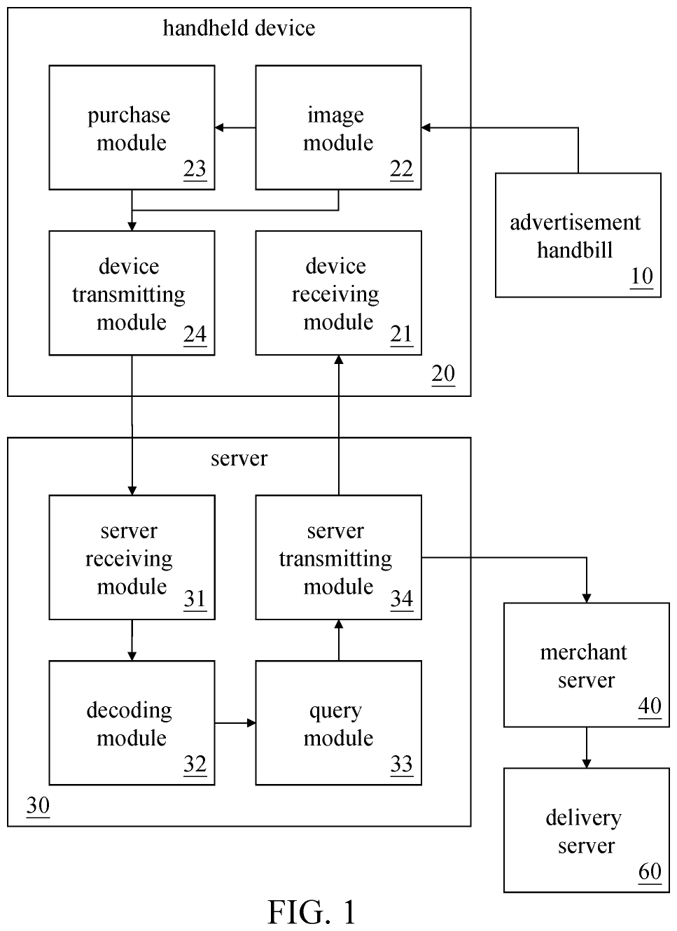

Please refer to FIG. 1, which is a system block diagram of a product information presentation and smart purchase system of the present invention. The product information presentation and smart purchase system of the present invention is described in following paragraphs with reference to FIG. 1.

As shown in FIG. 1, the product information presentation and smart purchase system includes a handheld device 20, a server 30, and a merchant server 40. The handheld device 20 includes a device receiving module 21, an image module 22, a purchase module 23, and a device transmitting module 24. The server 30 includes a server receiving module 31, a decoding module 32, a query module 33 and a server transmitting module 34.

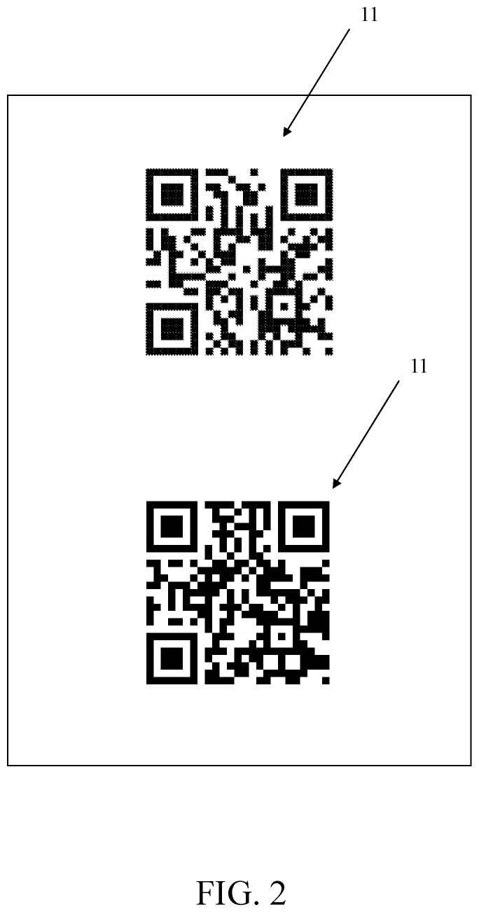

Please refer to FIG. 2, which is a schematic view of a plurality of two-dimensional product barcodes in the product information presentation and smart purchase system of the present invention.

As shown in FIG. 2, a plurality of two-dimensional product barcodes 11 can be provided, and each two-dimensional product barcode 11 has product information, such as a product name, a product code and so on; however, these examples are merely for exemplary illustration, and the application field of the present invention is not limited to these examples. Furthermore, the content of the two-dimensional product barcode 11 shown in is merely for exemplary illustration, and the application field of the present invention is not limited to the example. The two-dimensional product barcode 11 can be presented on a physical device, a physical location, or a virtual display. In particular, the two-dimensional product barcode 11 can be disposed on a wall of a store by adhering, projecting, spray-painting, etc.; the two-dimensional product barcode 11 is disposed on a desk provided by the store by adhering; the two-dimensional product barcode 11 is disposed on standing provided by the store by printing; the two-dimensional product barcode 11 is disposed on advertisement handbills by printing; or the two-dimensional product barcode 11 is display in a website; however, these examples are merely for exemplary illustration, and the application field of the present invention is not limited to these examples. The two-dimensional product barcode 11 printed on an advertisement handbill provided by the store, as shown in FIG. 2, is merely for exemplary illustration, and the present invention is not limited this example.

The buyer can use his handheld device 20 to scan the two-dimensional product barcode 11, the image module 22 of the handheld device 20 can obtain a product barcode image having one of the plurality of two-dimensional product barcodes 11 on an augmented reality image.

The handheld device 20 can be linked with the server 30 through wireless transmission, such as Wi-Fi or mobile communication network (such as 3G, 4G or 5G); however, these examples are merely for exemplary illustration, and the application field of the present invention is not limited thereto. The device transmitting module 24 of the handheld device 20 can transmit the product barcode image to the server 30, and the server receiving module 31 of the server 30 can receive the product barcode image from the device transmitting module 24 of the handheld device 20.

Next, the decoding module 32 of the server 30 decodes the two-dimensional product barcode 11 on the product barcode image to obtain product information. The decoding manner performed by the decoding module 32 of the server 30 on the two-dimensional product barcode 11 is well known in the art, so the detailed description is not repeated herein.

The query module 33 of the server 30 can query the three-dimensional product image 53 and the at least one piece of product display information 55 corresponding to the product information, which decoded and obtained by the decoding module 32 of the server 30.

After the query module 33 of the server 30 queries the three-dimensional product image 53 and the at least one piece of product display information 55 corresponding to the product information, the server transmitting module 34 of the server 30 transmits the three-dimensional product image 53 and the at least one piece of product display information 55 to the handheld device 20, and the device receiving module 21 of the handheld device 20 can receive the three-dimensional product image 53 and the at least one piece of product display information 55 from the server transmitting module 34 of the server 30.

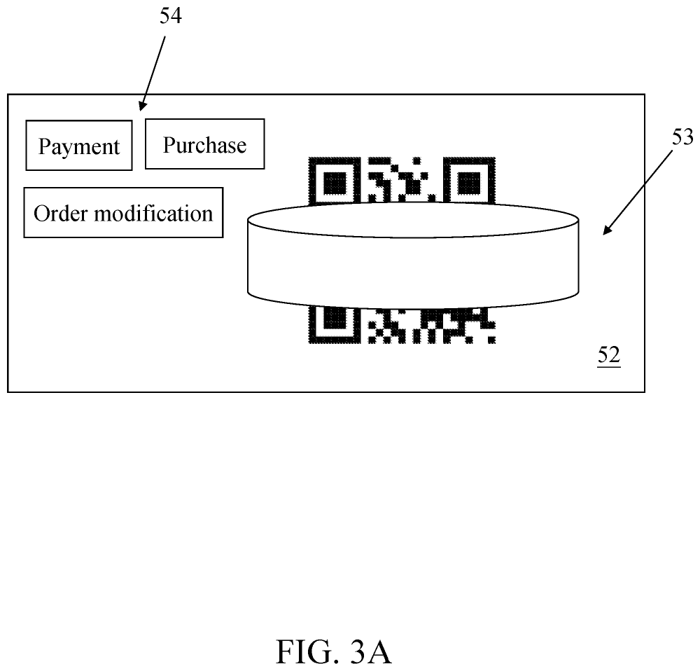

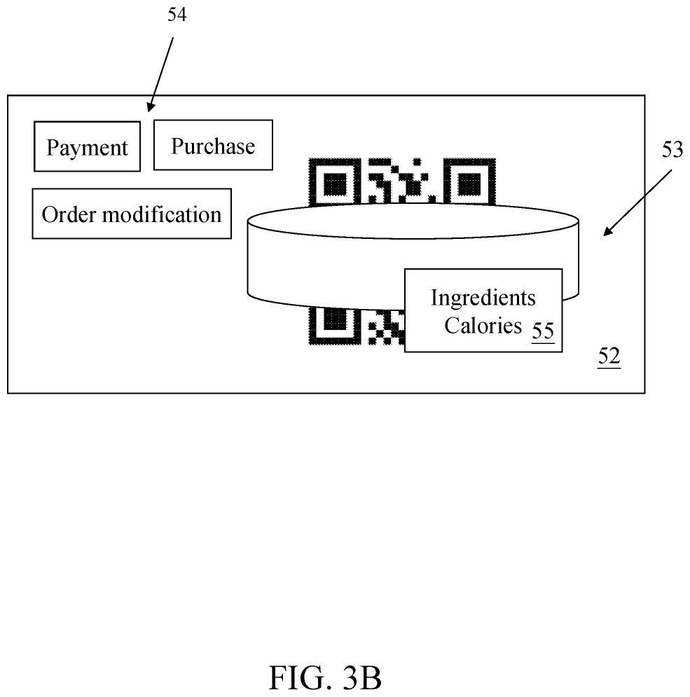

The image module 22 of the handheld device 20 displays the three-dimensional product image 53 at a position of the two-dimensional product barcode on the augmented reality image 52, and provides a virtual shopping user interface 54. In an embodiment, the virtual shopping user interface 54 can provide with a shopping cart function, a checkout function and a purchase order management function, and so on; however, these examples are merely for exemplary illustration, and the application field of the present invention is not limited these examples. Please refer to FIG. 3A, which is a schematic view of an augmented reality image in the product information presentation and smart purchase system of the present invention. For example, FIG. 3A schematically shows the augmented reality image 52, the three-dimensional product image 53 and the virtual shopping user interface 54.

The image module 22 of the handheld device 20 can provide with three-dimensional rotation display function on the three-dimensional product image 53, so as to provide multiple view angles for the user to view the product, and when the three-dimensional product image 53 is presented with a specific view angle, the image module 22 of the handheld device 20 can display the at least one piece of product display information 55 corresponding to the three-dimensional product image 53, as shown in FIG. 3B, which is a schematic view of product display information in the product information presentation and smart purchase system of the present invention.

After the buyer purchases the product corresponding to the one of the plurality of two-dimensional product barcodes 11 through the virtual shopping user interface 54 and the three-dimensional product image 53 provided by the image module 22 of the handheld device 20, the purchase module 23 of the handheld device 20 can generate a purchase order based on the purchased product, the quantity of the purchased product, buyer information (such as the buyer's name, contact information, and whether to be informed by SMS), pickup method, and so on; however, these examples are merely for exemplary illustration, and the application field of the present invention is not limited these examples.

The handheld device 20 can be linked with the merchant server 40 through wireless transmission, such as Wi-Fi or mobile communication network (such as 3G, 4G or 5G); however, these examples are merely for exemplary illustration, and the application field of the present invention is not limited these examples. The device transmitting module 24 of the handheld device 20 can transmit the purchase order, which is generated by the purchase module 23 of the handheld device 20, to the merchant server 40, and after the merchant server 40 receives the purchase order from the device transmitting module 24 of the handheld device 20, the merchant server 40 can perform delivery of the purchased product. It should be noted that the product information presentation and smart purchase system can further include a delivery server 60, and the merchant server 40 can perform delivery of the purchased product through the delivery server 60. In an embodiment, the delivery server 60 can be, for example, Foodpanda, or UBEREATS; however, these examples are merely for exemplary illustration, and the application field of the present invention is not limited these examples.

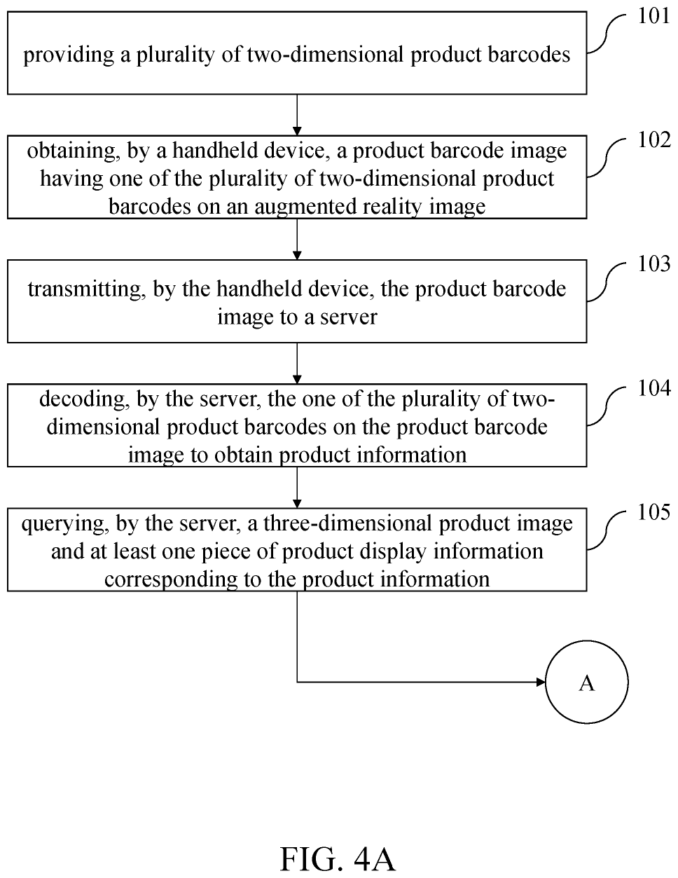

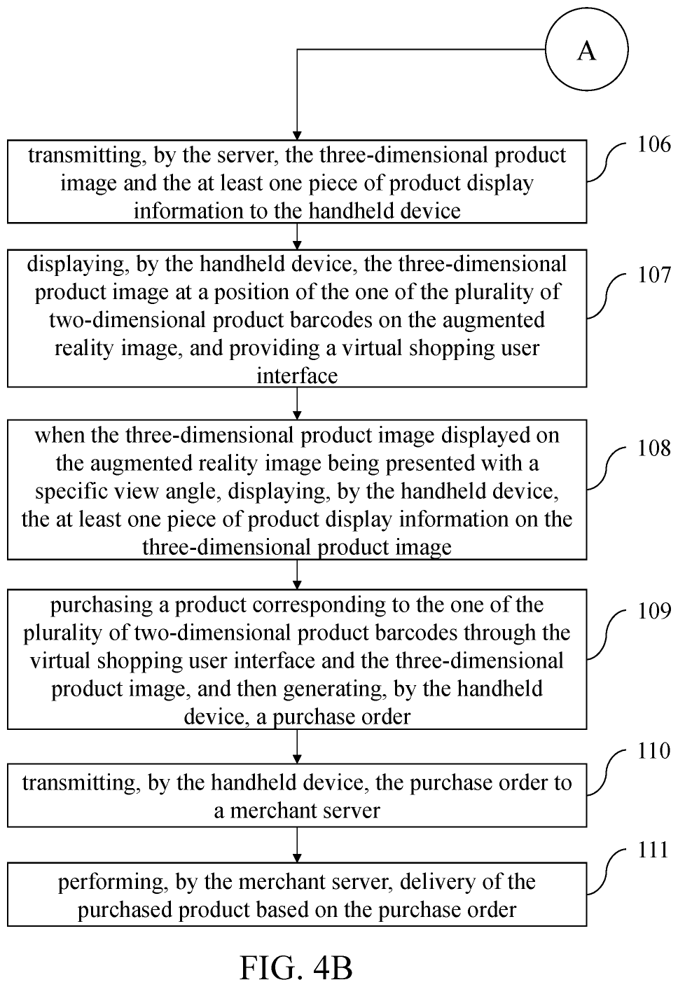

Please refer to FIGS. 4A and 4B, which are flowcharts of a product information presentation and smart purchase method of the present invention.

First, in the step 101, a plurality of two-dimensional product barcodes are provided, and in the step 102, the handheld device obtains a product barcode image having one of the plurality of two-dimensional product barcodes on augmented reality image. In the step 103, the handheld device transmits the product barcode image to a server, and in the step 104, the server decodes the one of the plurality of two-dimensional product barcodes on the product barcode image, to obtain product information. In the step 105, the server queries three-dimensional product image and at least one at least one piece of product display information corresponding to the product information, and in the step 106, the server transmits the three-dimensional product image and the at least one piece of product display information to the handheld device. Next, in the step 107, the handheld device displays the three-dimensional product image at the position of the one of the plurality of two-dimensional product barcodes on the augmented reality image, and provides a virtual shopping user interface. In the step 108, when the three-dimensional product image displayed on the augmented reality image is presented with a specific view angle, the handheld device displays the product display information, on the three-dimensional product image; next, in the step 109, the product can be purchased through the virtual shopping user interface and the three-dimensional product image, and the handheld device then generates the purchase order, and in the step 110, the handheld device transmits the purchase order to the merchant server. Eventually, in the step 111, the merchant server performs delivery of the purchased product based on the purchase order.

According to the above-mentioned content, the difference between the system and method of the present invention and the conventional technology is that the handheld device provides the product barcode image, which has one of the two-dimensional product barcodes, to the server, and the server then transmits the three-dimensional product image and the at least one piece of product display information back to the handheld device, the handheld device displays the three-dimensional product image in augmented reality and provides a virtual shopping user interface, and when the product corresponding to the one of the two-dimensional product barcodes is purchased through the virtual shopping user interface and the three-dimensional product image, the handheld device generates and provides the purchase order to the merchant server, and the merchant server performs delivery of the purchased product based on the purchase order.

Therefore, the technical solution of the present invention can solve the conventional technical problems that the existing product advertisement is not effective and it is inconvenient to purchase the product that is in the advertisement, so as to achieving the technical effect of displaying the product in augmented reality for smart purchase.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A product information presentation and smart purchase system, comprising:
a plurality of two-dimensional product barcodes;
a handheld device comprising:
a device receiving module configured to receive a three-dimensional product image and at least one piece of product display information;
an image module configured to obtain a product barcode image having one of the plurality of two-dimensional product barcodes on an augmented reality image, and display the three-dimensional product image at a position of the one of the plurality of two-dimensional product barcodes on the augmented reality image, and provide a virtual shopping user interface, and display the at least one piece of product display information on the three-dimensional product image when the three-dimensional product image is presented with a specific view angle;
a purchase module configured to purchase a product corresponding to the one of the plurality of two-dimensional product barcodes through the virtual shopping user interface and the three-dimensional product image, and generate a purchase order; and
a device transmitting module configured to transmit the product barcode image, and transmit the purchase order;
a server, comprising:
a server receiving module configured to receive the product barcode image from the device transmitting module;
a decoding module configured to decode the one of the plurality of two-dimensional product barcodes on the product barcode image, to obtain product information;
a query module configured to query the three-dimensional product image and the at least one piece of product display information corresponding to the product information; and
a server transmitting module configured to transmit the three-dimensional product image and the at least one piece of product display information to the device receiving module; and
a merchant server configured to receive the purchase order from the device transmitting module, and perform delivery of the purchased product.

2. The product information presentation and smart purchase system according to claim 1, wherein each of the plurality of two-dimensional product barcodes is presented on a physical device, a physical location, or a virtual display.

3. The product information presentation and smart purchase system according to claim 1, wherein the virtual shopping user interface provides with a shopping cart function, a checkout function, and a purchase order management function.

4. The product information presentation and smart purchase system according to claim 1, wherein the image module provides with a three-dimensional rotation display function on the three-dimensional product image displayed on the augmented reality image.

5. The product information presentation and smart purchase system according to claim 1, further comprising a delivery server, wherein the merchant server performs delivery of the purchased product through the delivery server.

6. A product information presentation and smart purchase method, comprising:
providing a plurality of two-dimensional product barcodes;
obtaining, by a handheld device, a product barcode image having one of the plurality of two-dimensional product barcodes on an augmented reality image;
transmitting, by the handheld device, the product barcode image to a server;
decoding, by the server, the one of the plurality of two-dimensional product barcodes on the product barcode image to obtain product information;
querying, by the server, a three-dimensional product image and at least one piece of product display information corresponding to the product information;
transmitting, by the server, the three-dimensional product image and the at least one piece of product display information to the handheld device;
displaying, by the handheld device, the three-dimensional product image at a position of the one of the plurality of two-dimensional product barcodes on the augmented reality image, and providing a virtual shopping user interface;
when the three-dimensional product image displayed on the augmented reality image being presented with a specific view angle, displaying, by the handheld device, the at least one piece of product display information on the three-dimensional product image;
purchasing a product corresponding to the one of the plurality of two-dimensional product barcodes through the virtual shopping user interface and the three-dimensional product image, and then generating, by the handheld device, a purchase order;
transmitting, by the handheld device, the purchase order to a merchant server; and
performing, by the merchant server, delivery of the purchased product based on the purchase order.

7. The product information presentation and smart purchase method according to claim 6, wherein each of the plurality of two-dimensional product barcodes is presented on a physical device, a physical location, or a virtual display.

8. The product information presentation and smart purchase method according to claim 6, wherein the virtual shopping user interface provides with a shopping cart function, a checkout function, and a purchase order management function.

9. The product information presentation and smart purchase method according to claim 6, further comprising the step of providing, by the handheld device, with a three-dimensional rotation display function on the three-dimensional product image displayed on the augmented reality image.

10. The product information presentation and smart purchase method according to claim 6, wherein the step of performing, by the merchant server, delivery of the purchased product based on the purchase order further comprises performing, by the merchant server, delivery of the purchased product based on the purchase order through a delivery server.
